(19) United States
(12) Patent Application Publication
(10) Pub. No.: US 2026/0359238 A1
(43) Pub. Date: Nov. 12, 2026

(54) PCIE RETIMER PROVIDING FAILOVER TO REDUNDANT ENDPOINT AND MULTIPLE ENDPOINT SWITCHING USING SYNCHRONIZED MULTI-TILE DATA INTERFACE

(71) Applicant: Kandou Labs SA, Saint-Sulpice (CH)

(72) Inventors: Jay Li Li, 19122079 (CH); Subhash Roy Roy, Saint-Sulpice (CH); Alexander Koch Koch, Saint-Sulpice (CH)

(73) Assignee: Kandou Labs SA, Saint-Sulpice (CH)

(21) Appl. No.: 19/122,079

(22) PCT Filed: Oct. 18, 2023
(86) PCT No.: PCT/US2023/077185

§ 371 Date: Apr. 17, 2025

Related U.S. Application Data
(60) Provisional application No. 63/380,041, filed on Oct. 18, 2022.

(51) Int. Cl. G06F 13/16; G06F 13/42

(52) U.S. Cl. CPC G06F 13/1689; G06F 13/423; G06F 2213/0026

(57) ABSTRACT

Receiving, at an upstream pseudo-port having physical layer circuits (PHYs) spread across at least two circuit dies of a multi-die integrated circuit module (ICM), a plurality of serial data lanes, and responsively generating respective deserialized lane-specific data words, selecting a first or a second downstream pseudo-port having PHYs spread across the at least two circuit dies of the ICM, the first and second downstream pseudo-ports having respective PCIe data links to first and second endpoints, respectively, storing the deserialized lane-specific data words for each serial data lane in corresponding PCS-mode FIFOs associated with the selected downstream pseudo-port, the corresponding PCS-mode FIFOs having output alignment across the plurality of serial data lanes received at the at least two circuit dies, and providing the deserialized lane-specific data words for transmission via the PHYs of the selected downstream pseudo-port.

### CROSS-REFERENCE TO RELATED APPLICATIONS

This application claims the benefit of U.S. Application No. 63/380,041, filed Oct. 18, 2022, entitled “PCIE RETIMER PROVIDING FAILOVER TO REDUNDANT ENDPOINT AND MULTIPLE ENDPOINT SWITCHING USING SYNCHRONIZED MULTI-TILE DATA INTERFACE”, which is hereby incorporated herein by reference in its entirety for all purposes.

### BACKGROUND

With increased data rate in PCIe 5.0 (32 Gbps) compared to previous generations (e.g., PCIe 4.0 MAX 16 Gbps), the channel reach becomes even shorter than before, and the need for retimers becomes more evident. Typical channels comprise system boards, backplanes, cables, riser-cards and add-in cards. Connections across these kinds of channels—often combinations of these channels and their sockets—usually have losses that exceed the specified target loss of −36 dB at 16 GHz. Retimers extend the channel reach to get across the border to what is possible without a retimer.

Retimers break a link between a host (root complex, abbreviated RC) and a device (end point) into two separate segments. Thus, a retimer re-establishes a new PCIe link going forward, which includes re-training and proper equalization implementing the physical and link layer.

While redrivers are pure analog amplifiers that boost the signal to compensate for attenuation, they also boost noise and usually contribute to jitter. Retimers instead comprise analog and digital logic. Retimers equalize the signal, retrieve their clocking, and output a signal with high amplitude and low noise and jitter. Furthermore, retimers maintain power states to keep system power low.

Retimers were first specified in PCIe 4.0. For PCIe 5.0, the usage of retimers is expected. FIGS. 1 and 2 show typical applications for retimers, in accordance with some embodiments. In FIG. 1, one retimer is employed. The retimer is located on the motherboard, and logically the retimer is between the PCIe root complex (RC) and the PCIe endpoint.

FIG. 2 shows the usage of two retimers. The first retimer is similarly located on the motherboard, while the second retimer is on a riser card which makes the connection between the motherboard and the add-in card containing the PCIe endpoint.

In complex PCIe systems, the number of PCIe endpoints can be significantly higher than the number of free PCIe ports. In such scenarios, switch devices may be used to extend the number of PCIe ports. Switches allow for connecting several endpoints to one root point, and for routing data packets to the specified destinations rather than simply mirroring data to all ports. One important characteristic of switches is the sharing of bandwidth, as all endpoints share the bandwidth of the root point.

### BRIEF DESCRIPTION

Methods and systems are described for receiving, at a upstream pseudo-port having physical layer circuits (PHYs) spread across at least two circuit dies of a multi-die integrated circuit module (ICM), a plurality of serial data lanes, and responsively generating respective deserialized lane-specific data words, selecting a first or a second downstream pseudo-port having PHYs spread across the at least two circuit dies of the ICM, the first and second downstream pseudo-ports having respective PCIe data links to first and second endpoints, respectively, storing the deserialized lane-specific data words for each serial data lane in corresponding PCS-mode FIFOs associated with the selected downstream pseudo-port, the corresponding PCS-mode FIFOs having output alignment across the plurality of serial data lanes received at the at least two circuit dies, and providing the deserialized lane-specific data words for transmission via the PHYs of the selected downstream pseudo-port.

This Brief Summary is provided to introduce a selection of concepts in a simplified form that are further described below in the Detailed Description. This Brief Summary is not intended to identify key or essential features of the claimed subject matter, nor is it intended to be used as an aid in determining the scope of the claimed subject matter. Other objects and/or advantages of the present invention will be apparent to one of ordinary skill in the art upon review of the Detailed Description and the included drawings.

### BRIEF DESCRIPTION OF FIGURES

FIGS. 1 and 2 illustrate two usages of retimers, in accordance with some embodiments.

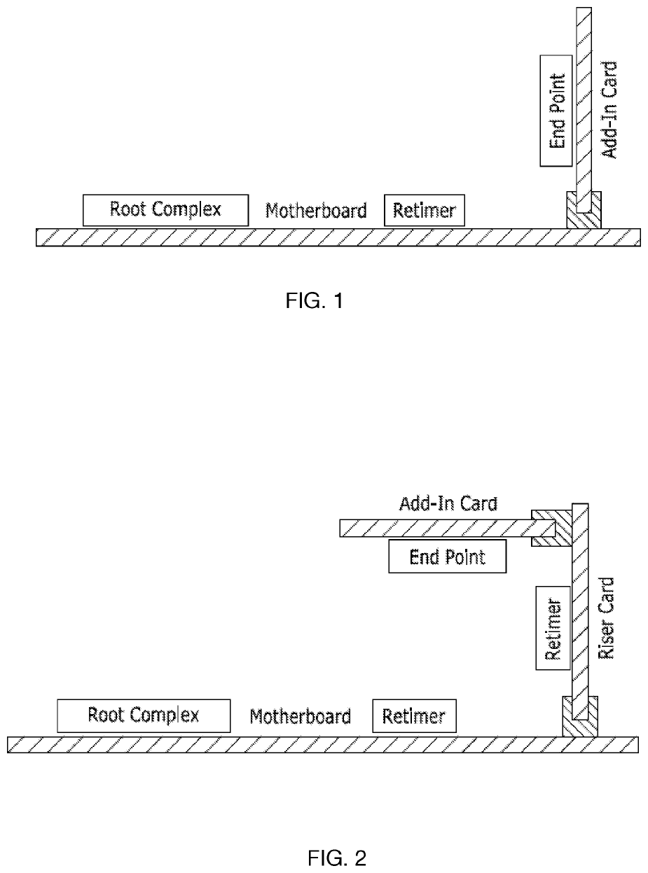

FIG. 3 is a block diagram of a multi-chip module (MCM) configuration having multi-tile alignment between two tiles, in accordance with some embodiments.

FIG. 4 is a block diagram of a MCM configuration having multi-tile alignment between four tiles, in accordance with some embodiments.

FIG. 5 is a block diagram of a two-tile MCM for providing a failover endpoint for a four-lane data link, in accordance with some embodiments.

FIG. 6 is a block diagram of a four-tile MCM for providing a failover endpoint for an eight-lane data link, in accordance with some embodiments, in accordance with some embodiments.

FIG. 7 is a block diagram of a two-tile MCM for providing multiple endpoint switching, in accordance with some embodiments.

FIG. 8 is a data flow for a retimer mode of operation, in accordance with some embodiments.

FIG. 9 is a block diagram for lane alignment in a tile of an integrated circuit module (ICM), in accordance with some embodiments.

FIG. 10 is a block diagram for performing rate adaptation between lanes in a tile of an ICM, in accordance with some embodiments.

FIG. 11 is a block diagram for performing lane alignment across tiles in a MCM, in accordance with some embodiments.

FIG. 12 is a block diagram of a write tile clock generator for synchronizing alignment between lanes in a MCM, in accordance with some embodiments.

FIG. 13 is a block diagram for performing rate adaptation between tiles in a MCM, in accordance with some embodiments.

FIG. 14 is a block diagram of a multiplexer crossbar switch, in accordance with some embodiments.

FIG. 15 is a block diagram illustrating the configuration of the tile-to-tile (T2T) Serial Peripheral Interface (SPI) bus in a four-tile embodiment.

FIG. 16 is a block diagram illustrating a complete signal path between central processing unit (CPU) core 1600 and each PHY on the various tiles in the multi-chip module.

FIG. 17 is a timing diagram for multi-tile rate adaptation, in accordance with some embodiments.

FIG. 18 is a flowchart of a method, in accordance with some embodiments.

### DETAILED DESCRIPTION

Despite the increasing technological ability to integrate entire systems into a single integrated circuit, multiple chip systems and subsystems retain significant advantages. For purposes of description and without limitation, example embodiments of at least some aspects of the invention herein described assume a systems environment of at least one point-to-point communications interface connecting two integrated circuit chips representing a root complex (i.e., a host) and an endpoint, (2) wherein the communications interface is supported by several data lanes, each composed of four high-speed transmission line signal wires.

Retimers typically include PHYs and retimer core logic. PHYs include a receiver portion and a transmitter portion. A PHY receiver recovers and deserializes data and recovers the clock, while a PHY transmitter serializes data and provides amplification for output transmission. The retimer core logic performs deskewing (in multi-lane links) and rate adaptation to accommodate for frequency differences between the ports on each side.

Since the retimer is located on the path between a root complex (e.g., a CPU) and an endpoint, the retimer adds additional value. An integrated processing unit, e.g., an accelerator, may be integrated into the retimer performing data processing on the path from the root complex to the end point. In some embodiments, an endpoint may correspond to an input/output (I/O) device, such as a monitor, keyboard, mouse. CD/DVD ROM, storage device, printer, or scanner. In some embodiments, an endpoint may be an add-in card, a network interface controller (NIC), a network processor, or various other devices that may be coupled to an electronic system.

To allow for a highly flexible solution, the PCIe retimer has normal PHY interfaces towards the PCIe bus and a high-speed die-to-die interconnect towards a data processing unit (DPU). The high-speed die-to-die interconnect allows for very high-speed communication links between chiplets in the same package. The PCIe retimer circuit is a chiplet, a die, with a four-lane retimer and the capability to connect to a DPU chiplet via the high-speed die-to-die interconnect. One, two or four lanes can be bundled into a multi-lane link where data is spread across all of the links. It is also possible to configure each lane individually to form a single-lane link. In the PCIe retimer, each lane employs two PHYs, one on each end (up- and downstream ports). Considering four lanes, eight PHYs are used in one PCIe retimer die. The PCIe retimer die also contains communication lines which allow for exchanging control information between two or more PCIe retimer dies.

The following can be built using one (or more) PCIe retimer chiplet(s). These are discussed in more detail below:
4-lane retimer
Single die, with full flexible 4×4 static lane routing
4-lane retimer with accelerator (DPU)
Two dies in one package, a retimer die and a DPU die
8-lane retimer
Two dies in one package, limited static lane routing—flexible 4×4 routing on same die but no data crossing die boundaries
8-lane retimer with full flexible lane routing
Two dies in one package, data crossing chiplets are routed through high-speed die-to-die interconnect at the cost of additional delay.
8-lane retimer with accelerator (DPU)
Three dies in package, two retimer dies and a DPU die
16-lane retimer
Four dies in one package, limited static lane routing—flexible 4×4 routing on same die but no data crossing die boundaries

### Chip Configurations

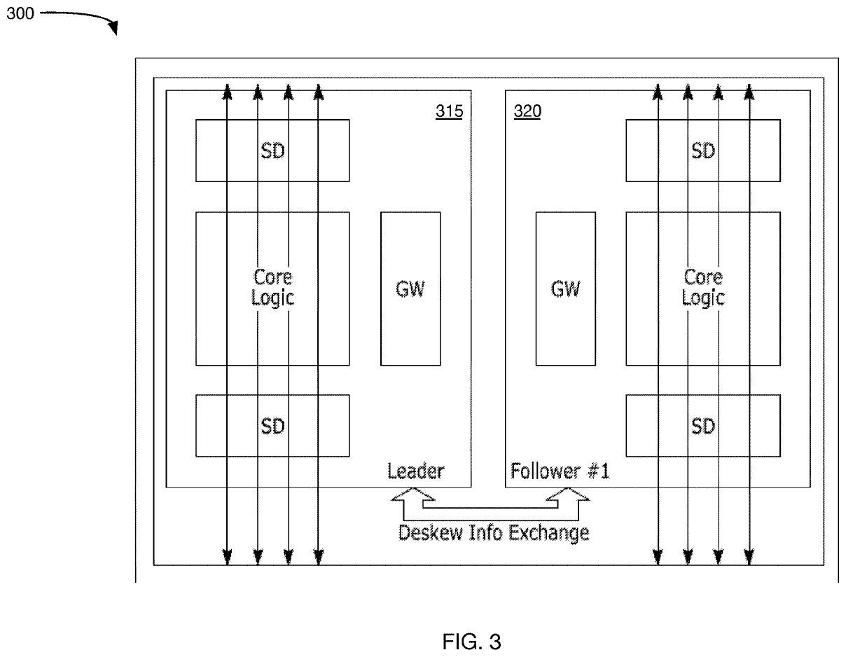

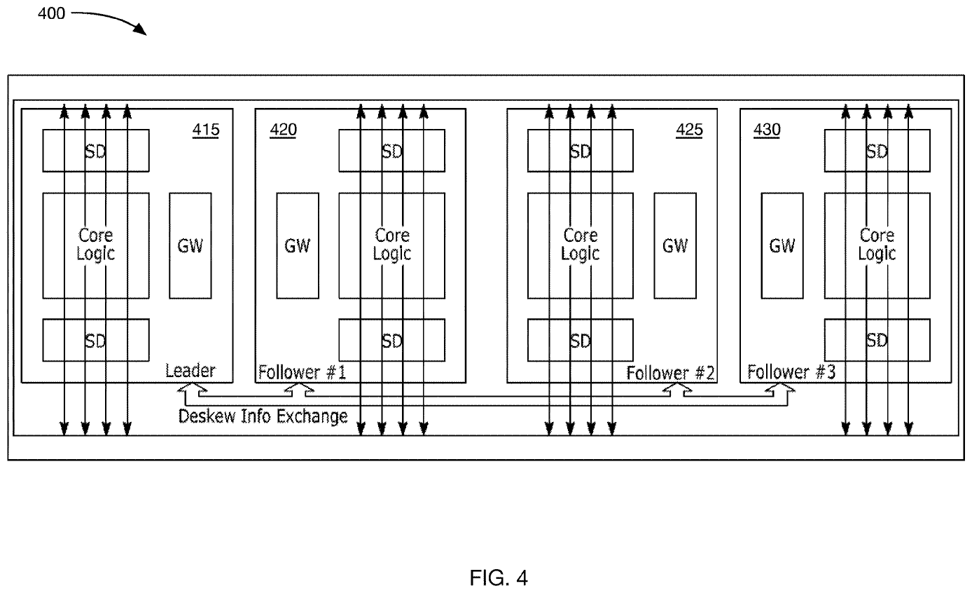

FIGS. 3 and 4 illustrate configurations of a multi-die ICM from a data flow perspective, in accordance with some embodiments. FIG. 3 illustrates a chip configuration for an ICM 300 configured as an 8-lane retimer having two four-lane bundles and routing capabilities within each bundle. Communication links are included to exchange lane deskew and rate adaptation information between tiles/circuit dies 315 and 320. FIG. 4 illustrates a similar configuration of an ICM 400 for a 16-lane retimer having four circuit dies 415/420/425/430, each circuit die handling four lanes with lane deskew and rate adaptation information exchanged between dies. Multi-die lane alignment and rate adaptation is discussed in further detail below.

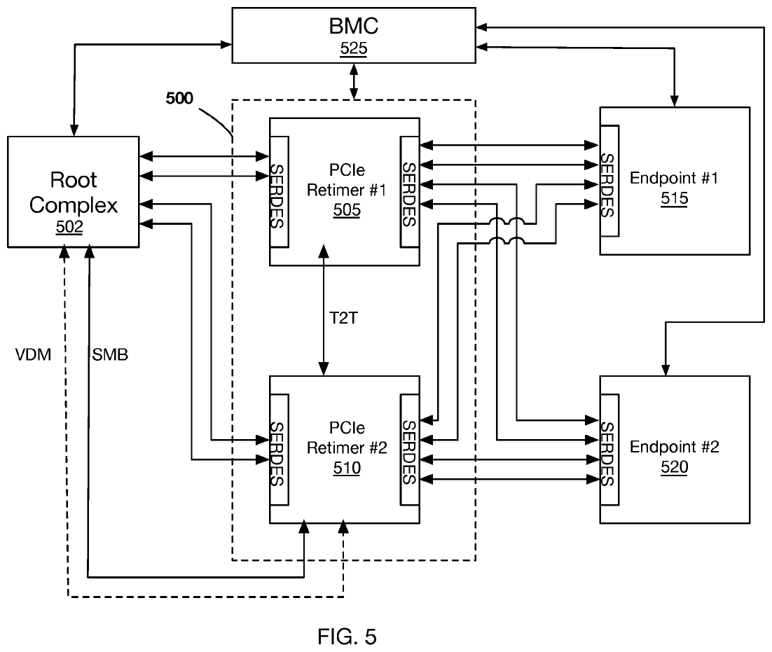

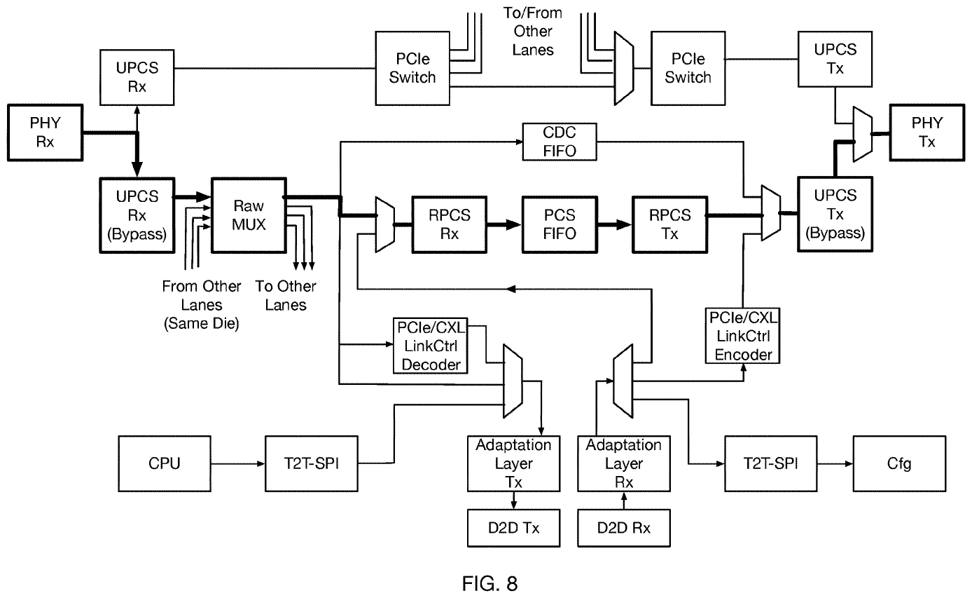

FIG. 8 is a data flow diagram that may be used, e.g., in the chip configuration of FIG. 3 or 4, in accordance with some embodiments. Specifically, FIG. 5 illustrates the physical coding sublayer (PCS) retimer path for one lane, in which a serial data lane is received on an upstream serial data transceiver, converted into deserialized lane-specific data words, which are routed via the multiplexing crossbar switch to a corresponding rate adaptation and lane deskew buffer after having been decoded. The deserialized lane-specific data words are read from the buffer, re-encoded, and output on a downstream serial data transceiver.

### Multi-Die ICM Providing Endpoint Switching

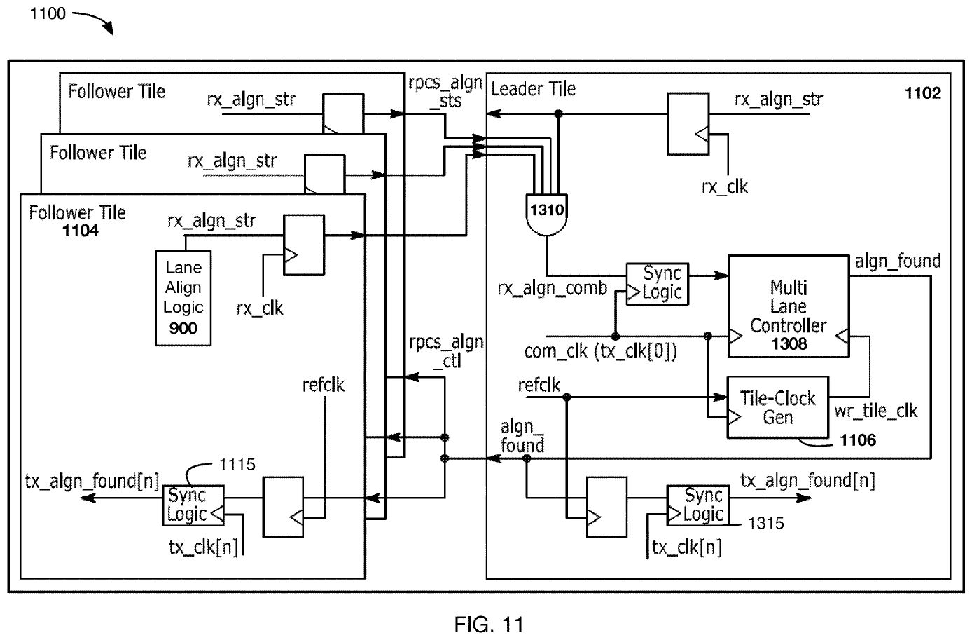

In some embodiments, a multi-die ICM provides endpoint switching utilizing multiple tiles having synchronized data lanes across the tile boundaries. Such a configuration may be used for e.g., endpoint redundancy or endpoint resource sharing, described in more detail below. FIG. 5 is a block diagram of such a chip configuration for a multi-die ICM 500, in accordance with some embodiments. As shown, a plurality of serial data lanes output by root complex 502 are received at a group of PHYs of an upstream pseudo-port distributed across at least two circuit dies 505 and 510 of multi-die ICM 500. In the context of a retimer mode of operation, a “pseudo-port” may indicate that the circuit dies do not perform data link or transaction layer protocols, and only perform physical layer functions. A pseudo-port may include a physical layer transceiver including serializing and deserializing functionalities, and may also be referred to herein as a “PHY” or “serdes”. The plurality of serial data lanes are associated with a PCIe data link. Respective deserialized lane-specific data words are generated by the receiver portions of the PHYS of the upstream pseudo-port. Lane routing logic on the first and second circuit dies select a first or a second downstream pseudo-port having PHYs distributed across the least two circuit dies of the ICM 500. The first and second downstream pseudo-ports have respective PCIe data links to the first endpoint 515 and second endpoints 520, respectively. The deserialized lane-specific data words for each serial data lane are stored in corresponding PCS-mode FIFOs associated with the selected downstream pseudo-port. As shown in FIG. 5, the PCS-mode FIFOs have output alignment across the plurality of serial data lanes received at the at least two circuit dies using multi-tile lane deskewing and rate adaptation techniques described below, specifically in the descriptions of FIGS. 11-13. The deserialized lane-specific data words are provided for transmission via the PHYs of the selected downstream pseudo-port to the respective endpoint.

In some embodiments, the corresponding PCS-mode FIFOs have read pointer locations set responsive to detection of alignment symbols in each of the plurality of serial data lanes. In such embodiments, the read pointer locations are synchronously set responsive to an alignment pulse signal ‘algn_found’ generated using the multi-lane controller and the tile-clock generator according to a reference clock shared between the first and second circuit dies. As shown in FIG. 11, the alignment pulse ‘algn_found’ is generated by a leader tile and distributed to the follower tiles.

In some embodiments, the PHYs of the first downstream pseudo-port are connected to a primary endpoint, which may correspond to endpoint 515 in FIG. 5. The PHYs of the second downstream pseudo-port are connected to a secondary or spare endpoint, which may correspond to endpoint 520 in FIG. 5.

In some embodiments, the selection of the second group of downstream PHYs occurs responsive to a failure with the PCIe link to the primary endpoint. Such a failure in the link may be associated with a failure in the primary endpoint itself, and thus configuration parameters of the ICM may be useful for diagnostic purposes. For example, the root complex and/or ICM may obtain and provide configuration parameters indicating that the PCIe data link to the spare endpoint has been activated, thus indicating that repairs may be needed by either the primary endpoint itself, or by a portion of the PCIe data link to the primary endpoint. In such a scenario, the primary endpoint may be repaired or replaced and the ICM be configured to reactivate the PCIe data link to the primary endpoint.

FIG. 5 includes a board management controller (BMC) 525. BMCs may be included on e.g., motherboards to monitor the state of components and hardware devices on the motherboard utilizing sensors, and communicating the status of such devices e.g., to the root complex. In some embodiments, the BMC 525 monitors the status of the PCIe link between root complex 502 and endpoint 515. In such embodiments, monitoring the status of the PCIe link includes bit error rate measurements, for the upstream and downstream data paths. The bit error rate exceeding a threshold value may indicate a failure in the PCIe link on one or more lanes, which may initiate a link retraining sequence between root complex 502 and endpoint 515. If consecutive link retraining sequences fail, a fatal failure in the PCIe link may be present, and the multi-die ICM 500 may establish a link between the root complex 502 and Endpoint 520, which in some embodiments is a redundant endpoint. In such embodiments, endpoints 515 and 520 may be network interface controllers (NICs). If a failure between root complex 502 and endpoint 515 acting as the primary endpoint fails, the lane routing logic in the first and second circuit dies 505 and 510, respectively, may be configured to reroute the traffic from the root complex to the backup or redundant endpoint 520 utilizing a different group of selected downstream serial data transceivers. Normal operation may resume until e.g., routine service is performed on the system and functionality for a PCIe link to the primary endpoint is restored. In some embodiments, the configuration status of the multi-die ICM 500 may indicate the point of a failure, and thus such configuration settings may be accessed and read by e.g., the BMC 525. Root Complex 502, or other diagnostic equipment to assess systems and/or hardware devices in need of repair. In such embodiments, the configuration status may be obtained via e.g., the SMBus between devices, or may be conveyed utilizing control skip ordered sets as vendor-defined messages (VDMs).

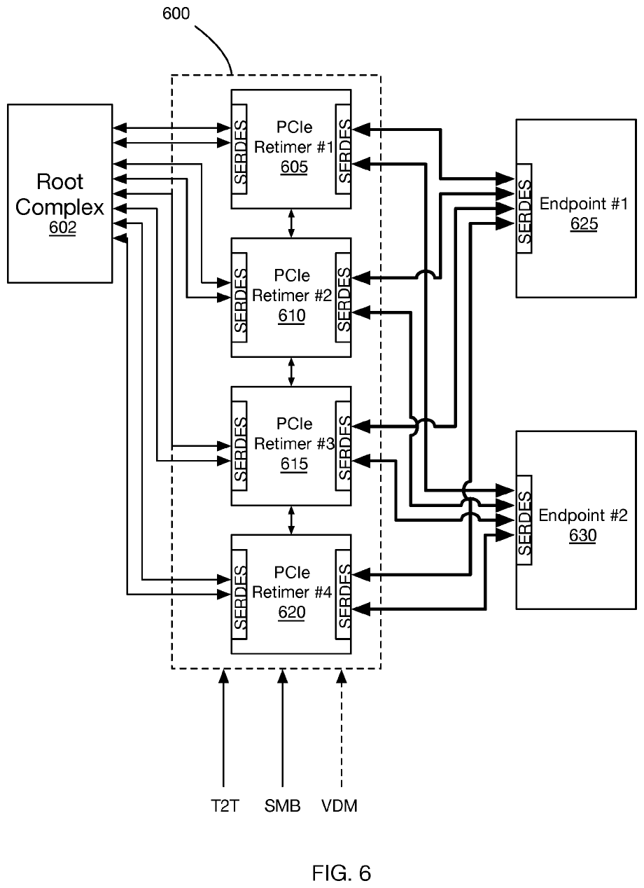

FIG. 6, a block diagram of a root complex 602 connected to ICM 600 is configured to provide a failover to a redundant endpoint for an eight lane PCIe data link, in accordance with some embodiments. The configuration is like the four-lane PCIe data link embodiment shown in FIG. 5. As shown, root complex 602 provides two lanes of the eight lane PCIe data link to each of the four circuit dies 605/610/615/620. The four circuit dies are configured to select a first or second group of downstream serial data transceivers for PCIe data links connected to the primary endpoint 625 and redundant endpoint 630, respectively. As shown, the ICM 600 may be configured via T2T connections, a SMBus, or a virtual channel using VDMs as described above. One of the four circuit dies is designated as a leader tile and configures the follower tiles with e.g., lane alignment across the PCS-mode FIFOs. While not explicitly shown, FIG. 6 may include a BMC configured to perform similar tasks described above with respect to FIG. 5. In FIG. 6, each endpoint has a respective two-lane connection to each retimer circuit die as illustrated by the bolded lines, without implying limitation. While embodiments described herein contemplate MCMs with circuit dies each having eight pseudo-ports, neither the number of circuit dies in an MCM or the available pseudo-ports should be considered limiting, as MCMs may have packages with more than four circuit dies and/or circuit dies having more or fewer pseudo-ports.

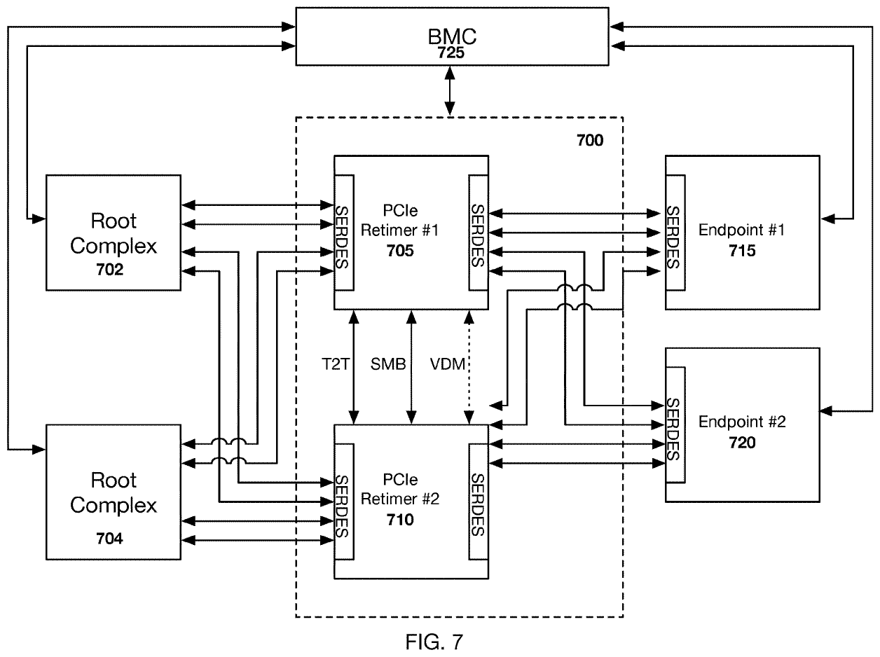

FIG. 7 is a block diagram of a multi-die ICM 700 configured to provide multiple endpoint switching, in accordance with some embodiments. As shown, FIG. 7 includes two root complex devices, root complex 702 and root complex 704, each connected to respective upstream pseudo-ports of the retimer circuit dies 705 and 710 in multi-die ICM 700. As shown in FIG. 7, endpoints 715 and 720 are connected to downstream pseudo-ports of the multi-die package 700. Root complexes 702 and 704 are each connected to the multi-die package 700 via respective four-lane data links, as are endpoints 715 and 720. As shown, each four-lane data link connecting the root complexes and endpoints to the ICM 700 is distributed across the two circuit dies 705 and 710 as two two-lane links. FIG. 7 further includes a board management controller (BMC) 725. In addition to performing tasks described above with regard to FIG. 5, the BMC 725 may be configured to manage the multiple root complexes in FIG. 7. Specifically, endpoints 715 and 720 may correspond to shareable resources for expensive functions such as artificial intelligence (AI), to shareable computer-readable mediums such as hard-disk drives (HDDs) or solid state drives (SSDs), amongst other endpoint devices. In such embodiments, the BMC 725 may coordinate usage of the endpoints by the root complex devices, i.e., so that both root complex devices do not try to establish connections with the same endpoint device at the same time. In some embodiments, the BMC may utilize credit-based techniques to share the multiple endpoints between the multiple root complex devices.

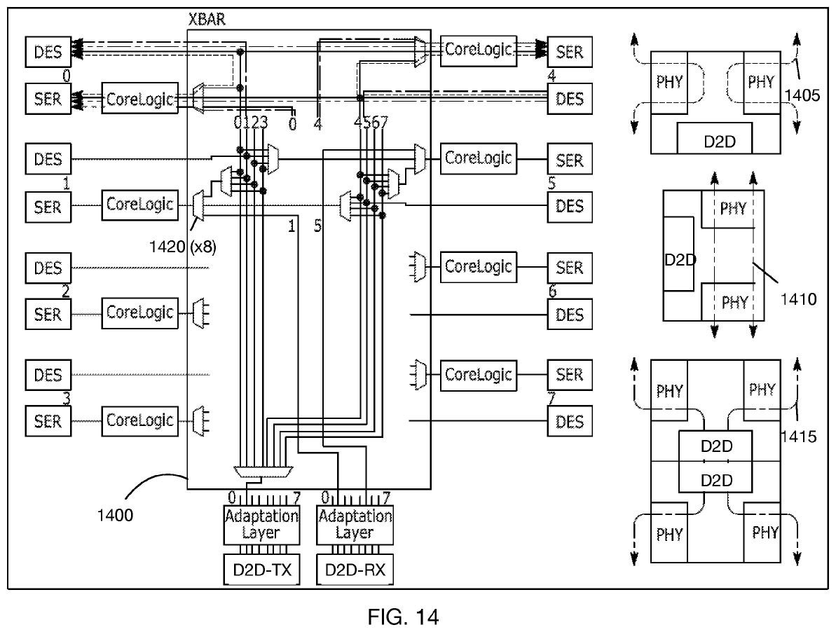

FIG. 14 is a block diagram of a lane routing logic 1400 for lane routing in a retimer circuit die of an ICM, in accordance with some embodiments, also referred to herein as a “Raw MUX”. FIG. 14 includes a block diagram on the left and various lane routing configurations on the right. In the top lane routing configuration 1405, data is fed in through a deserializer, passes into the PHY and through the core logic and through the same PHY and output via the serializer down to the bottom. In the middle diagram 1410, the data is fed into one port, processed in the core logic and fed out at the opposite PHY on the bottom. Finally, in the bottom drawing 1415, all data is fed into the PHYs at the top side of one PCIe retimer circuit and from there directly forwarded to the high-speed die-to-die interconnect. From there data is fed through the core logic and then to the PHYs on the bottom side of the other PCIe retimer die. In all such scenarios, there are data paths in the opposite direction as well.

On the left side of FIG. 14, a sketch of the Raw MUX logic is shown. The serial data transceiver PHYs are numbered from 0 to 7 and include receiver deserializers (DES) and transmitter serializers (SER). The top lane (PHY #0 and #4) illustrates the three different data paths matching the data paths shown on the right. Data path 705 on the right corresponds to data coming in on PHY 0 of the PCIe retimer circuit leaving on the same PHY #0 on the left-hand side of FIG. 14. Path 1410 shows a feed-through path where data received on PHY 0 passes through to PHY #4 as shown on the left-hand side of FIG. 14. Finally, path 1415 indicates that all received data is directly forwarded to adaptation layer to be transmitted over the inter-die data interface. On the second PCIe retimer, data from the inter-die data interface is forwarded to the core logic, where it is processed and output on the attached PHY.

The second lane (PHY #1 and #5) indicate the multiplexing capabilities. Each core-logic/transmitter path can receive data from each of the eight lanes. Additionally, data can be obtained from the inter-die data interface. The other lanes (PHY #0 with #4, PHY #2 with #6 and PHY #3 with #7) have the same switching capabilities. On the bottom, the multiplexing for one lane to the inter-die data interface is shown. Any input PHY can be select for each lane entering the high-speed die-to-die interconnect. Thus, some embodiments may mirror data by selecting the same received PHY data for multiple adaptation layer physical ports. Details on port mirroring embodiments are described in more detail below.

Switching a data path in the Raw MUX includes the 32-bit received data bus carrying the deserialized lane-specific data words, accompanying data enabled lines, the recovered clock, and the corresponding reset. It is important to note that only raw data is multiplexed, the received data is not processed in any way. The Raw MUX logic is statically configured via configuration bits, the switching itself happens asynchronously. In case the Raw MUX settings are changed during mission mode, invalid data and glitches on the clock lines are likely. Thus, the multiplexing logic setup may be changed during reset.

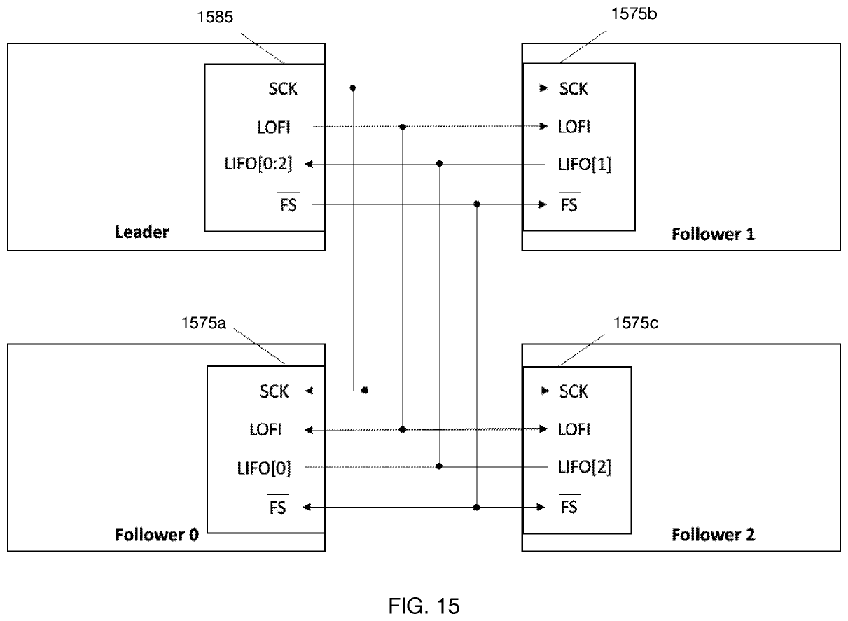

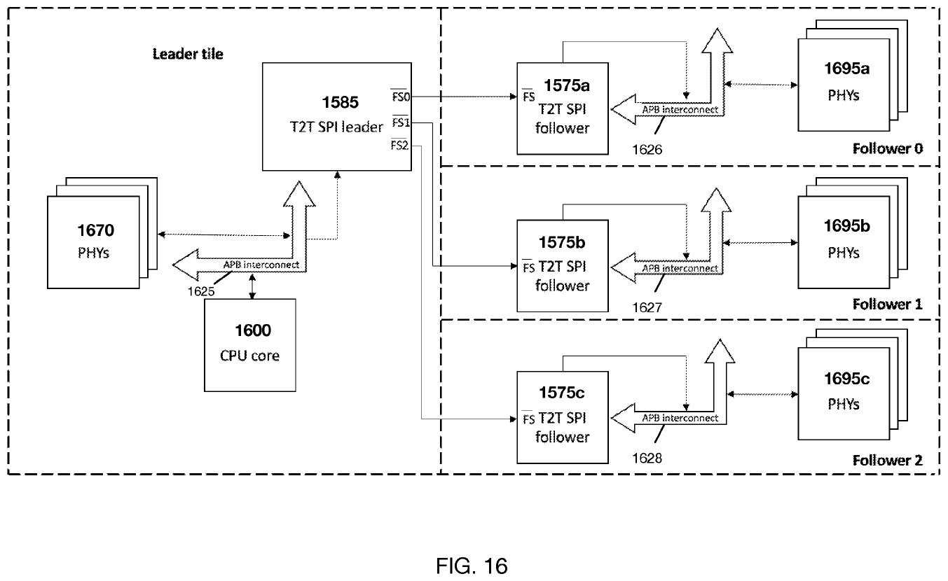

In some embodiments, each circuit die includes a routing logic such as the Raw MUX for lane routing between and within circuit dies. In such an embodiment, a primary circuit die, also referred to as a “leader” may perform the configuration of the Raw MUX in each circuit die, e.g., by writing to the configuration registers associated with the Raw MUX. FIGS. 15 and 16 illustrate such tile-to-tile communications. FIG. 15 provides a schematic of the configuration of the T2T SPI bus in the four-tile case. This specific number of tiles is not limiting as the principles described herein can be extended to a N tile retimer having one leader tile and N−1 follower tiles, N≥2.

The T2T SPI leader 1585 includes a serial clock line SCK that carries a serial clock signal generated by T2T SPI leader 1585. The SCK signal is received by all T2T SPI followers and is used to co-ordinate reading and writing of data over the T2T SPI bus.

T2T SPI leader 1585 also includes a MOSI line (Leader Out Follower In) and MISO line (Leader In Follower Out). The MOSI line is used to transmit data from the leader to the follower. i.e. as part of a write operation. The MISO line is used to transmit data from the follower to the leader, i.e. as part of a read operation.

T2T SPI leader 1585 further includes a F̅S̅ line (Follower Select). This is used to signal which follower is to participate in the current operation of the bus—that is, which follower data or a command on the bus is intended for. For convenience a single wire is shown for the follower select line in FIG. 15 but in practice one wire can be present for each line, i.e. three separate follower select wires in the case of FIG. 15.

T2T SPI followers 1575a, 1575b and 1585c are each also coupled to all of the lines discussed above to enable two-way communication between the T2T leader and follower. In this manner, communication between tiles is achieved.

FIG. 16 shows the complete signal path between CPU core 1600 and each PHY on the various tiles in the multi-chip module.

CPU core 1600 is connected to PHYs 1670 on the leader tile via leader tile APB interconnect 1625 and can thus communicate with PHYs 1670 via APB interconnect 1625. CPU core 1600 is also connected to T2T SPI leader 1585 via leader tile APB interconnect 1625. T2T SPI leader 1585 is part of the T2T SPI bus that enables CPU core 1600 to communicate with other tiles.

As shown in FIG. 16, each follower tile includes a respective T2T SPI follower 1575a, 1575b. 1575c. Each of these SPI followers is coupled to T2T SPI leader 1585 to enable signaling between tiles.

Each SPI follower 1575a, 1575b, 1575c is coupled to respective PHYs 1695a, 1695b, 1695c via respective follower tile APB interconnects 1626, 1627, 1628. Each SPI follower 1575a, 1575b, 1575c is leader on the respective APB interconnect 1626, 1627, 1628. This enables each SPI follower to access all registers that are located on the tile that the SPI follower is also located on.

Communication between tiles thus makes use of two distinct busses and protocols. SPI protocol does not support addressing, but the APB protocol does. Part of the data put onto the T2T SPI bus by CPU core 1600 is APB address information, to enable the local APB interconnect on each follower tile to route messages to the intended recipient PHY.

Each PHY is assigned a unique APB address or APB address range so that it is possible for CPU core 1600 to write to and/or read from one specific PHY on any tile. From the perspective of the CPU core 1600, the entire multi-tile module has a single address space that includes separate regions for each PHY.

Assuming for the sake of illustration 24-bit APB addresses and a 32-bit data word size, control information put onto the SPI bus can be of the following format. This is referred to herein as a ‘control packet’.

| | | | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|---|
| r | r | r | r | r | s | s | s | a | a | a | a | a | a | a | a | a | a | a | a | a | a | a | a | a | a | a | a | a | a | a | a |

Bits 0-23 are address bits (‘a’), bits 24, 25 and 26 are follower select bits and bits 27-31 are reserved bits (‘r’). In this particular case there are three follower select bits because there are three followers tiles (and hence three T2T SPI followers) in this example. The reserved bits provide space for additional follower select bits—in this case, up to eight follower select bits can be provided, supporting up to eight follower tiles. The principles established here can be extended to any number of follower tiles by increasing the word size.

The address bits form an APB address. The T2T-SPI followers are each configured as bus leader on their respective local APB interconnects, enabling each T2T-SPI follower to instruct its respective APB interconnect to perform a write or read operation to one of the respective PHYs the APB bus is coupled to. In some cases the address data can be omitted because the T2T-SPI bus can auto-increment addresses such that it already knows which address to write data to or read data from. The address data can be provided to the local APB interconnect after receipt of the control packet by the respective T2T SPI follower, enabling the local APB interconnect to route commands and data to the correct local PHY.

The follower select bits enable the control packet to specify which follower select line should be activated, i.e. which tile data is to be written to or read from. The T2T SPI bus uses the follower select bits to control the follower select lines F̅S̅₁̅, F̅S̅₂̅, F̅S̅₃̅, where e.g. a 0 indicates the corresponding follower select line should be low and a 1 indicates a corresponding follower select line should be high.

Follower select control information can alternatively be sent separately from the APB address data. The follower select information could be sent in-band as illustrated above, or another channel could be used such as a System Management bus (SMBus). The address data can be sent separately and before the data package is transmitted. In some cases the address data can be omitted because the T2T SPI bus can auto-increment addresses such that it already knows which address to write data to.

In either case, once the follower select and address information (if required) has been provided, data can be transmitted. The T2T SPI leader 1585 can keep the follower select line(s) asserted until it receives new instructions regarding follower select line configuration. Similarly, the relevant APB interconnect(s) can continue writing to the address(es) specified (possibly by auto-incrementing) until new addressing information is provided. In this way, data and commands can be transmitted to, and received from, any PHY on any tile.

The APB address space is a global address space across all tiles. This means it is possible to address any register on any tile via this global address space. One particular configuration provides a base address for each tile that is given by a tile identifier multiplied by a constant. The tile identifier can be a tile number and the constant can be a base address for the leader tile. Other memory space constructions are possible. Each register on each tile has a unique address or address range assigned to it within this global address space. Each PHY of PHYs 1670, 1695a, 1695b, 1695c thus has a unique address or address range assigned to it.

The CPU core on the leader tile may coordinate the lane switching circuits in both tiles. The CPU core on the follower tile may be in a low power state. As shown, a SPI communications bus between the two tiles may be used to configure the switching circuit in the follower tile to select between the first and second sets of downstream serial data transceiver ports. In some embodiments, a die-to-die (D2D) interface may be present and configured to configure lane routing between the leader and follower tiles. I.e., serial data streams received on upstream ports of the leader tile may be routed to downstream ports of the follower tile and vice versa. Such a D2D interface may also be configured to carry configuration information as sideband information from the leader tile to the follower tile, e.g., to configure the configuration registers of the follower tile. In another embodiment, the configuration of the raw crossbar MUX may be performed via a system management bus, which may be further connected to the root complex. In some embodiments, a virtual channel between the root complex and retimer chip may be used for configuration purposes. In such embodiments, vendor-defined messages (VDMs) may be present in particular vendor-defined packet fields of a PCIe data transmission. Such VDMs may be detected, extracted, and provided to the CPU of the leader circuit die using e.g., an interrupt protocol. In some embodiments, each follower tile may have a specific tile ID, and configuration register write commands can be assigned to certain tile IDs.

In some embodiments, the leader tile may initialize the configuration registers of the Raw MUX of the follower tile such that the RX adaptation layer ports are statically mapped to downstream ports to the redundant endpoint. In such an embodiment, the leader tile can switch the routing of the deserialized lane-specific data words between (i) downstream ports on the same die to the primary endpoint and (ii) the adaptation layer to be routed via the D2D interface.

### Multi-Lane Deskewing

Deskewing and rate adaptation are related to each other and are implemented in the same block (Deskew & Rate-Adjust Control). First the lane-to-lane skew is compensated. This process is also known as lane alignment and is typically done using a FIFO. For this purpose, alignment symbols are detected in the data stream. Due to the skew between lanes, these alignment symbols are received at different times in each lane. In the deskewing process, the received alignment symbols are stored into the FIFO and the location of these alignment symbols within the FIFO is also stored. This happens independently in all lanes using the recovered clocks of each lane independently. When the alignment symbols of all lanes are stored within their respective FIFOs, data is read from the FIFO starting from the read pointer defining the location where the alignment symbol was stored. On the read-side, this happens at the same time in all lanes with a common clock so that the first data output from the FIFO corresponds to the alignment symbols. The FIFO fill level is observed, and depending on the fill level, skip ordered sets for rate adaptation is either inserted if the FIFO fill level is almost empty or removed if the FIFO level is almost full. In such a scenario, rate adaptation symbols are used for this purpose. When these rate adaptation symbols are seen at the same time in all lanes (which is the case after the deskewing process), the data can be either removed or duplicated (inserted) at the same time in all lanes. Rate adaptation is described in more detail below.

One challenge addressed below is that in retimer mode, all transmitters are synchronized to a common reference clock. However, in a retimer, it is typical that each data lane has its own read clock and that no common read clock is available. The read clock essentially corresponds to the transmit clock of the attached serializer. Another challenge involves exchanging alignment and FIFO status between all tiles within a multi-tile system.

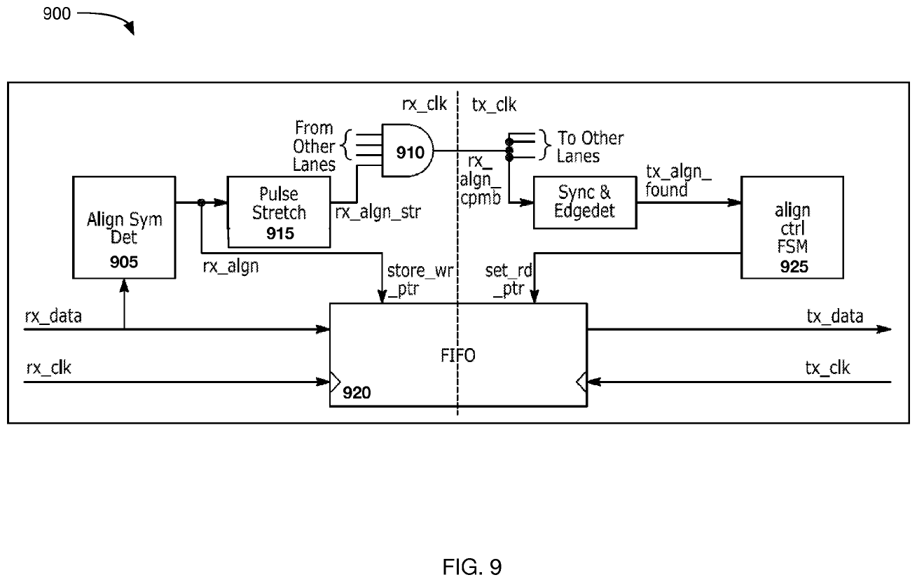

FIG. 9 is a block diagram illustrating lane alignment logic 900 for performing lane deskewing concept in a PCIe retimer circuit, in accordance with some embodiments. In some embodiments, a method for performing lane deskewing includes independently detecting, using alignment symbol detection logic 905, an alignment symbol within a first-in-first-out (FIFO) buffer 920 in each data lane according to a recovered clock signal rx_clk, and responsively generating a single cycle pulse rx_algn responsive to detection of the alignment symbol. Once the alignment symbol is stored, the location within the FIFO is also stored as a write pointer, which may further include storing the bit-level start position of the alignment symbol within the 32-bit location of the FIFO. In some embodiments, the alignment symbol is a 32-bit symbol. It should be noted that since encoded data is stored in the FIFO, the block boundary continuously changes and thus the block boundary of the alignment symbol is stored as well. The method further includes independently generating a lane-specific alignment found pulse rx_algn_str for each data lane, e.g., by stretching, using pulse stretch logic 915, the alignment detection pulse rx_algn, indicating that the alignment symbol is stored in the FIFO. In some embodiments, the length of the pulse depends on the required deskewing capabilities. For example, when N is the maximum deskewing capability (in clock cycles), then the length of the pulse L=ceil(N+2). In such an embodiment. N is defined by the maximum input skew plus the skew introduced by the deserializers (which is bitwidth—1 UI) and the synchronizer. The stretched alignment pulses of all data lanes is asynchronously combined via a tile-specific AND gate 910 indicating that alignment symbols are stored in the FIFOs of all data lanes for the tile. It should be noted that since the read clocks of each data lane are independent, the AND combination is performed prior to synchronization. In some embodiment, the AND combination is built from instantiated tech cells to prevent glitches at the input of the synchronizer. In each data lane, the AND-ed signal rx_algn_comb is synchronized to the aligned transmit clock tx_clk. The rising edge of the synchronized signal is detected. Stretching the alignment pulse rx_algn_str as described above by two additional clock cycles beyond the required deskew capabilities ensures that even in a scenario that maximum skew is present between two data lanes, the remaining pulse width is at least two clock cycles long. Such a length is sufficient for secure clock domain crossing, as the clock domain changes from the rx_clk in the receiver to the tx_clk in the transmitter. In some embodiments, the FIFO read clocks of all lanes are aligned to a common reference clock in retimer mode. A single-cycle rising edge pulse output from the alignment control finite state machine (FSM) 925 is used to set the read pointer of the FIFO to be equal to the stored write pointer, thus setting the current read location of the FIFO to be the location of the alignment symbol. As the rising edge pulse has been synchronized for all FIFOs, the read pointer update occurs at the same time in all FIFOs. Since encoded data is stored in the FIFO, alignment may include adjustment of an internal barrel shifter to accommodate for the different block boundary locations in different lanes. Furthermore, since the read clocks are independently aligned to the common reference clock, a minimum skew equal to a single clock cycle may continue to exist between the data lanes. Such a skew is accepted and within the transmit skew budged defined by the PCIe base specification. Alignment may cause a discontinuity in the data stream sent downstream. In some embodiments, a configuration bit selecting between outputting a fixed pattern (e.g., a high-speed 1010 pattern) or outputting previously received data, accepting the discontinuity. Once the lanes have been deskewed, reading from the FIFOs continues and the alignment symbols are output from all the FIFOs at the same time. In some embodiments, a barrel shifter may be used to adjust the effective FIFO read position so that reading begins with the sync header bits of the alignment symbol. Since encoded data is stored in the FIFO, the location of an alignment ordered set may start anywhere in the FIFO. In one lane, the alignment ordered set may start in bit 3, in another at bit 19, and in yet another at bit 11. After alignment, the first bit of the alignment ordered set must start at bit 0. The barrel shifter allows the shifting of all bits of a word by a certain number of bits. In this example, the data from the first lane may be shifted 3 bits, the data of the second land shifted 19 bits, and the data of the third lane shifted 11 bits. It should be noted that as the sync header bits are part of the data stream, no further action is required for 128b130b encoded data streams.

### Rate Adaptation

After successful deskewing, the FIFO fill level is observed and depending on the fill level, skip (SKP) ordered set symbols for rate adaptation are either inserted if the FIFO fill level is becoming empty or removed if the FIFO fill level is becoming full. As the data lanes have been deskewed, the rate adaptation symbols are seen at the same time in all lanes, they can be either removed or duplicated (inserted) at the same time in all lanes, rate adaptation may be performed to maintain the current fill level of the FIFOs of each data lane.

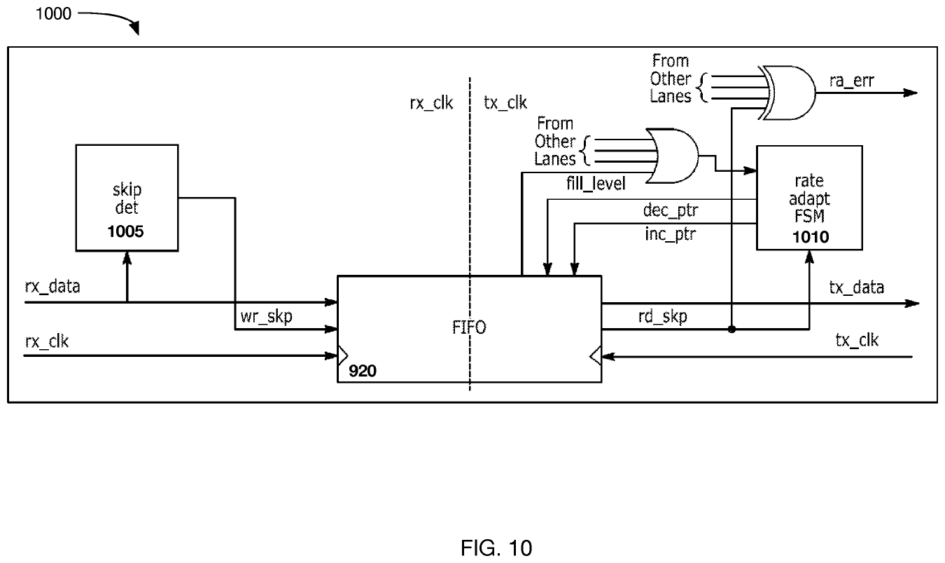

FIG. 10 illustrates a block diagram of rate adaptation logic 1000, in accordance with some embodiments. In FIG. 10, a single cycle pulse wr_skp is issued responsive to the detection of a skip symbol using skip symbol detection logic 1005. The pulse is issued independently in all lanes on the recovered clock (FIFO write clock, rx_clk respectively). The skip pulse is fed to the FIFO 920 as side-band information, and is stored one memory location in advance—not together with the corresponding skip symbol itself. As shown, the same FIFO from the lane deskew 920 is used for rate adaptation, however some embodiments may utilize separate FIFOs for each function. In some embodiments, utilizing the same buffer to perform both lane-to-lane deskew and rate adaptation operations reduces the overall latency of the retimer path. On the FIFO read side, having the information if there is a skip or not present one clock cycle before the skip symbol is read allows for either removing the skip symbol (called a “truncation”) or inserting a symbol, e.g., by reading the skip symbol twice, (also called “padding”).

As described above, the fill level of all FIFOs is observed using rate adaptation FSM 1010. When any FIFO indicates that the FIFO is full, a “truncation” is performed, and a skip symbol is removed concurrently from all FIFOs. In some embodiments, removing the skip symbol corresponds to double incrementing the read pointer of the FIFO for one clock cycle. Similarly, when any FIFO indicates FIFO empty, a “padding” is performed. In such a scenario, a skip symbol is inserted concurrently in all FIFOs. In some embodiments, the existing symbol is read twice, and the FIFO read pointer is not incremented for one clock cycle.

Skip symbol insertion or removal is only possible if a skip symbol is stored in the FIFO. The skip side-band information, which becomes active one clock cycle before the actual skip symbol would be read and output, triggers padding or truncation. The skip indication dec_ptr, inc_ptr is present in all FIFOs at the same time. If the skip indication is not present in all FIFOs concurrently, a rate adaptation error (ra_err of FIG. 10) is issued.

In some embodiments, a flag is issued when the FIFO pointer wraps back to the starting location of the FIFO. The flag is synchronized into the FIFO read side and then the FIFO read pointer value is evaluated. In some embodiments, the MSB of the FIFO write pointer is synchronized to the FIFO read side performing a rising edge detection on the synchronized signal and to evaluate the read pointer value. The FIFO stores all data until it is possible to perform rate adaptation to avoid losing data. In a worst case scenario, the FIFO-full or FIFO-empty indication occurs right after a skip symbol passed into the FIFO. At least one additional word is stored until the next skip symbol arrives. In some embodiments, the skip symbols are not distributed equidistantly, and the FIFO size is increased accordingly. To avoid FIFO-write and -read pointers converging on each other (which would result in the FIFO read side reading unstable data), additional FIFO fill level indications may be provided. In one scenario, if the FIFO is full and no rate adaption decreased the FIFO fill level, a FIFO overflow indication is issued as an error flag. In another scenario, if the FIFO is empty an no rate adaption increased the FIFO fill level, a FIFO underflow indication is issued as an error flag.

Rate adaptation in 128b130b modes (PCIe Gen-3/4/5) happens in chunks of 32 bits. Since the sync header bits are part of the data stream, and thus the length of an ordered set is not a multiple of 16 or 32, the exact location of skip ordered sets changes. Insertion or removal of 32-bit chunks thus account for ordered set boundaries. In some embodiments, the sync header bits are stored as side-band information, and thus the ordered set boundaries are maintained.

### Multi-Tile Deskewing

As described above, a root complex device may bifurcate a multi lane data link across a plurality of circuit dies. Such embodiments may rely on multi-tile deskew and rate adaptations described below to ensure that the lane-to-lane skew between lanes on different circuit dies stays within the accepted skew tolerance as defined in the PCIe specification. Methods and systems are described below to perform both lane deskewing and rate adaptation across multiple tiles depending on configuration, despite constraints such as transmitting signals over slow I/O pads that provide connections between the circuit dies. In a single-die implementation the exchange of deskew information as well as FIFO status information between two or multiple lanes (up to four in a single die implementation) for rate adaptation can be done at maximum speed (1 GHz clock frequency). However, multi-die implementations utilize an alternative approach. In multi-die implementations, deskew and FIFO status/rate adaptation information is exchanged across two or four dies via slow I/O pads. This in turn means that the number of information exchange lines shall be as small as possible. FIG. 11 illustrates an integrated multi-die circuit module that performs multi-tile lane-to-lane deskew by exchanging skew information, in accordance with some embodiments. To minimize the number of connections, some considerations may be taken into account. First, as the bifurcation requirements in multi-tile retimers are limited, the alignment requirements for multi-tile configurations are limited as well. The alignment across several tiles is performed in multiples of four lanes. It is not required to support a bifurcation configuration of 2-4-2 lanes in an 8-lane retimer but only 8, 4-4, 4-2-2 or 2-2-4 (i.e., three times single-die operation) or eight lanes (i.e., 4 lanes distributed over two tiles). Similarly, in a 16-lane retimer, the supported tile-crossing bifurcation modes are 16, 8-8, 8-4-4 and 4-4-8.

As all data lanes of a given tile operate either independently or as a bundle as part of a larger link, the alignment information exchange is one bit per leader-follower tile, per direction. From a follower tile to the leader tile, one bit indicates that there are alignment symbols in the deskewing FIFO in all lanes of the follower tile. In FIG. 11, the signal ‘rpcs_algn_sts’, RPCS alignment status is the AND-ed alignment of all four lanes of a die (e.g., the output of the AND gate of FIG. 9). In the opposite direction, from leader tile to follower tiles, there is one bit indicating that an alignment symbol has been found in all lanes of the link and that all lanes should set the FIFO read pointer to continue reading from the location where the alignment symbol is stored (signal ‘rpcs_algn_ctl’, RPCS alignment control). In total this sums up to the following number of interface signals:
rpcs_algn_sts_o[1:0](follower out, one combination for 8-lane mode and one for the 16-lane mode)
rpcs_algn_sts_i[2:0](leader in)
rpcs_algn_ctl_o (leader out, distributed to 3 followers)
rpcs_algn_ctl_i (follower in)

The multi-tile deskewing operation is similar to the single-die mode described above. The method includes detecting an alignment symbol in each data lane in each tile and storing the write pointer position as sideband information. FIG. 11 illustrates an apparatus 1100 for performing lane-to-lane deskew in a chip package containing multiple circuit dies, i.e., tiles. As shown, the apparatus 1100 includes lane alignment logic 900, which may include e.g., symbol detection logic 905 configured to detect alignment symbols in FIFOs of a plurality of data lanes of a plurality of tiles, the plurality of tiles comprising a leader tile 1102 and one or more follower tiles 1104. FIG. 11 illustrates three follower tiles 1104, however such an embodiment should not be considered limiting.

FIG. 11 also includes a write tile clock generator 1106 in the leader tile configured to generate a write tile clock wr_tile_clk from a local system clock tx_clk[0], the write tile clock having a period equal to a period of a common reference clock refclk, the write tile clock corresponding to a pulse having a location within the period of the common reference clock as determined by an active cycle of a counter. In some embodiments, the location of the pulse of the write tile clock is associated with a tile-to-tile propagation time. In some embodiments, the location of the pulse of the write tile clock is programmable via adjustment of the active cycle of the counter.

FIG. 11 also includes a multi-lane controller 1108 in the leader tile configured to determine an alignment symbol has been detected in the FIFO of every lane of every tile, to generate an alignment found signal, and to transmit the alignment found signal to synchronization logic in each of the plurality of tiles responsive to the write tile clock. In some embodiment, the multi-lane controller includes a logical AND gate 1110 configured to determine the alignment symbols have been detected in the FIFO of every lane of every tile by performing a logical AND operation on tile-specific alignment found signals rpcs_algn_sts generated by each tile. In some embodiments, the tile-specific alignment found signals are generated using tile-specific logical AND gates in each tile configured to generate the tile-specific alignment found signals by performing a logical AND operation on the lane-specific alignment found signals associated with each data lane on a given tile. Such a tile-specific AND gate 910 is shown in the lane alignment logic 900 of FIG. 9. As shown in FIG. 9, the alignment symbol detection logic 905 is configured to generate each lane-specific alignment found signal as a pulse responsive to detection of the alignment symbol in the data lane. The lane alignment logic 900 further includes pulse stretching logic 915 configured to stretch the pulse for a predetermined number of locally-generated receive clock cycles.

As shown in FIG. 11, each tile further includes synchronization logic 1115. In each tile, the synchronization logic 1115 is configured to sample the alignment found signal according to the common reference clock, and to synchronize the alignment found signal to locally-generated system clocks tx_clk[n]. An alignment control state machine, e.g., 825 of FIG. 8, in each tile is configured to set read pointers of each FIFO 820 in the tile to a location containing the alignment symbol, and the plurality of FIFOs 820 are configured to output data according to the locally-generated system clocks.

In some embodiments, the lane alignment logic is configured to store the location containing each alignment symbol responsive to detection of each alignment symbol in the FIFOs of the plurality of data lanes. In FIG. 8, the write pointer address ‘store_wr_ptr’ is stored to indicate the address containing the alignment symbol.

In some embodiments, a maximum skew between the output data from each FIFO according to the locally-generated system clocks is at most one period of the locally-generated system clocks.

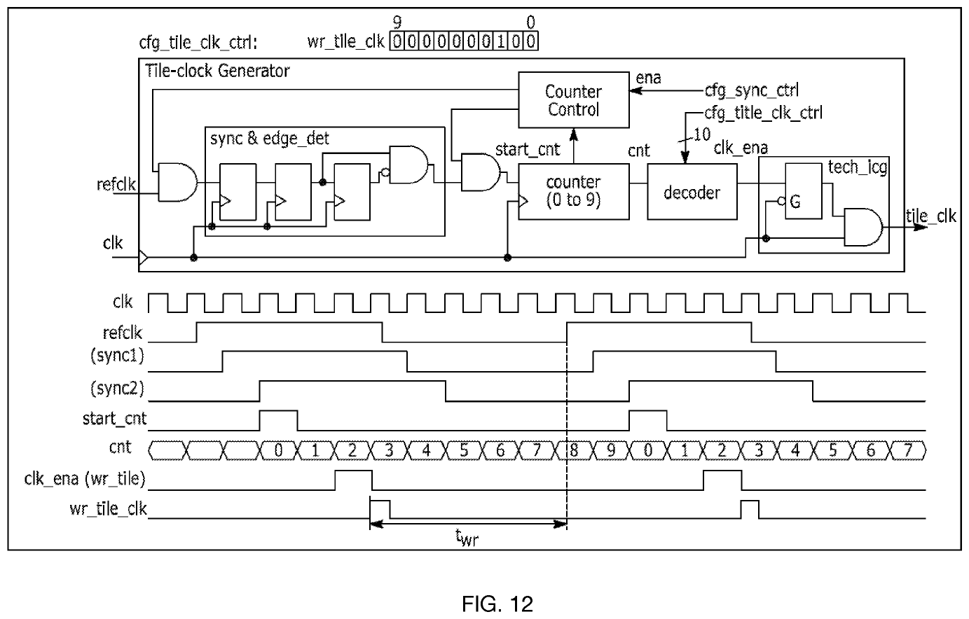

In some embodiments, the each tile further includes a ring counter 1605 having count values synchronized by the alignment found signal tx_algn_found. In some embodiments, each tile may further include rate adaptation logic 1200, as described above with respect to FIG. 12. The rate adaptation logic 1200 may be configured to monitor a FIFO fill level ‘fill_level’ of each FIFO of the plurality of data lanes using rate adaptation FSM 1210 and to generate a FIFO fill level status signal ‘rpcs_fifo_sts’ responsive to the FIFO fill level in one of the FIFOs exceeding a threshold. Skip symbol detection logic 1205 is configured to detect skip ordered sets in the FIFOs of each data lane, and the rate adaptation FSM 1210 pads or truncates skip ordered sets in each FIFO responsive to the FIFO fill level status signal, the padding or truncating performed according to predetermined count values of the ring counter in each tile. In some embodiment, the padding and truncating is performed by not incrementing or double incrementing the read pointer, respectively.

Referring to FIG. 11, the tile-specific alignment found signals rx_algn_str signal are an AND-ed combination of all stretched lane-specific alignment indications for each data lane belonging to the same link. The combined tile-specific alignment found signal for each follower tile is independently provided to the leader tile. It should be noted that since all the rpcs_algn_sts signals are output from flip flops and the stretching is sufficient, there is no risk of glitches when performing the AND combination and synchronization.

On the leader tile, the common alignment indication of all tiles (including one from the leader itself) is AND-combined to generate signal ‘rx_algn_comb’. If the output is active high, then an alignment symbol is seen in all lanes of all tiles and allows for initiation of the deskew process. Since the combined AND signal is asynchronous, it is first synchronized using a two flip-flop sync logic.

The synchronized common alignment signal indicates that alignment is found in all data lanes and sets the read pointer of the FIFOs of each lane to the position where the alignment symbol was stored. Subsequently, data is read from the FIFO concurrently in all lanes. In Gen-5 mode (32 GTps), the FIFO read pointer update happens synchronously at a clock frequency of 1 GHz. and the TX-skew budget allows for uncertainty of one clock cycle. There is no misalignment communication between the tiles after the initial alignment. Lane-to-lane alignment is performed initially at startup, preferably with hysteresis. Furthermore, as no alignment indications are available after the training, there is no alignment lost indication from follower tile to the leader tile.

### Multi-Tile Clocking

One challenge for performing multi-tile lane deskewing is transmitting a 1 GHz signal over I/O pads that are capable of handling toggle frequencies of up to 200 MHz (corresponding to rise/fall times of ~2.5 ns), whereas a toggle frequency of 500 MHz is required (rise/fall times of <1 ns). To work around such a limitation, a tile clocking concept is utilized, as described below. In summary, a balanced, synchronous 100 MHz reference clock is distributed from the leader tile to all tiles (leader and follower tiles) which allows for synchronization across all tiles. Both the leader tile and follower tiles set the read pointer of the FIFO according to the location identified by the corresponding stored write pointer and generate a local 1 GHz clock tx_clk┌n┐ based on the common 100 MHz reference clock.

The clocking mechanism showing the clock domain crossing scheme is shown in the bottom of FIG. 8. The leader tile contains a locally-generated 1 GHz-based write tile clock ‘wr_tile_clk’ which is active one cycler per 10 ns, thus matching the period of the 100 MHz reference clock. Outbound alignment control signals (e.g., algn_found) are clocked with the write tile clock, and subsequently sampled on each leader and follower tile by the synchronous common 100 MHz reference clock. With an appropriate timing of the write tile clock, this allows for a setup time (t_{wr} in the timing diagram of FIG. 12) from write tile clock-to-reference clock of more than 4 ns, which is enough time to cross the path from one tile to another tile via the IO pads and substrate routing. After the refclk-clocked flip-flop, there is a synchronize stage which synchronizes the alignment found signal to the locally generated 1 GHz lane-based tx_clk.

The write tile clock is generated in a tile-clock generator. FIG. 12 illustrates logic and timing diagrams of such a tile-clock generator. The write tile clock is synchronous to the reference clock, and for this purpose the reference clock is synchronized with a 1 GHz working clock. The rising edge triggers a counter from 0 to 9. A programmable decoder allows for a sequence which is active for one arbitrarily selected cycle (i.e., counter value). The active cycle is used to create a gated clock based on the 1 GHz working clock resulting in a tile clock which is active one out of 10 cycles.

The upper part of the timing diagram of FIG. 12 shows the synchronization of the reference clock and the generation of the enable pulse for the gate clock, the write tile clock, t_{wr} is the time between the generating clock on the leader tile and the 100 MHz sampling clock refclk on the follower tile. The time t_{wr} is programmable, and based on timing constraints, should be more than 4 ns. In some embodiments, t_{wr} is programmed based on setup and/or hold requirements and may be adjusted by selecting one of the values for the counter for which wr_tile_clk is active. For example, if the value of ‘0’ is chosen, the setup time is increased (at the cost of lowering the hold time before the next cycle), while if a value of ‘4’ is chosen, the setup time is decreased (thereby increasing the hold time (before the next cycle). The source for the write tile clock is a common 1 GHz clock on the leader tile, e.g., tx_clk[0] (PHY transmit clock lane 0).

Since all ‘algn_found’ signals are synchronized to the common 100 MHz reference clock and to the lane based transmit clock tx_clk┌n┐ individually, there may be an uncertainty of at most a single 1 GHz clock cycle (1 ns), which fits very well within the required skew tolerance of 1.25 ns for the Gen-5 mode.

In the schematic of FIG. 12 there is an additional counter control logic. This logic serves at least two purposes: (i) it allows disablement of the refclk synchronizer stage when it is not used to increase lifetime and (ii) it allows disablement of restarting the counter. The counter control unit observes the start_cnt pulse from time to time checking for drift.

In the above multi-tile deskew algorithms, the following factors may be taken into consideration regarding latency:
rx_algn_str transmitted from follower tile to leader tile;
synchronization of the combined rx_algn_comb signal
synchronizing the sync'ed signal with wr_tile_clk;
transmitting the resulting algn_found signal from leader to follower tile and
sampling the algn_found signal with refclk and then with rd_tile_clk

In total, the above delay sums up to about 20 to 25 ns compared to the single-die alignment where the delay is about 7 to 12 ns. The delay can be reduced to 5 to 12 ns using rate adaptation by adjusting the fill level of the FIFO, as described in more detail below. When the targeted FIFO fill level is set to a minimum value, the skip (SKP) ordered set will be taken out of the data stream resulting in a lower latency.

### Multi-Tile Rate Adaptation

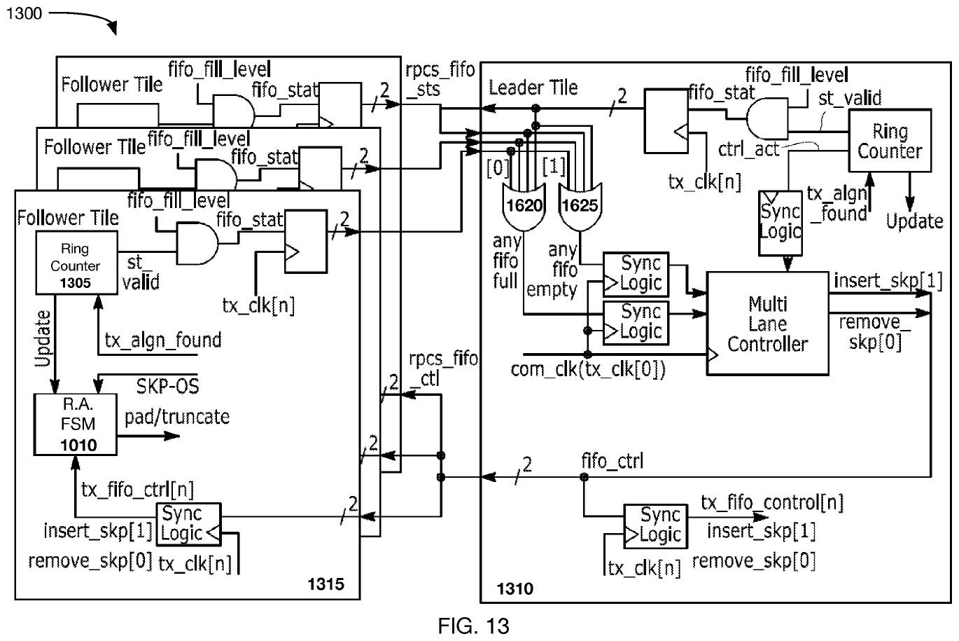

FIG. 13 is a block diagram illustrating information exchange for multi-tile rate adaptation, in accordance with some embodiments. The information to be exchanged includes two bits in each direction: two bits indicate the FIFO fill level (status) and two bits indicate the derived FIFO adjustment action (control). Each tile observes the FIFO levels of all lanes belonging to the link. If any FIFO indicates FIFO full, the tile reports FIFO full to the leader tile. Similarly, if any lane-FIFO of the link indicates FIFO empty, the tile reports FIFO empty to the leader. For the case that one FIFO indicates full whereas another FIFO indicates empty is an error condition and is reported to the leader tile.

As shown in FIG. 13, an apparatus 1300 for performing multi-tile rate adaptation includes a plurality of ring counters 1305, each ring counter contained within a respective tile of a multi-tile package, the plurality of ring counters configured to incrementally output a synchronization pulse. As shown in FIG. 13, the multi-tile package includes one leader tile 1310 and three follower tiles 1315, without implying limitation. The leader tile 1310 in the multi-tile package is configured to synchronize the synchronization pulses and count values of the plurality of ring counters 1305 according to an alignment found signal ‘tx_algn_found’. As described above, the alignment found signal is generated according to the write tile clock described above, and is synchronized into each tile according to the common reference clock and is thus skewed between tiles by no more than a single clock pulse of the locally generated system clocks.

FIFO fill level detection logic in the leader tile is configured to detect, after a first synchronization pulse, a FIFO fill level of a FIFO in a given tile of the multi-tile package has exceeded a threshold, and to output a rate adaptation control signal ‘rpcs_fifo_ctl’ to each tile of the multi-tile package. As shown in FIG. 13, the FIFO fill level detection logic in the leader tile includes two OR gates. OR gate 1320 configured to detect one lane's FIFO is full, and OR gate 1325 configured to detect one lane's FIFO is empty. Each tile includes a rate adaptation FSM 1010 configured to modify, after a subsequent synchronization pulse, a read pointer in each FIFO based on the rate adaptation control signal to pad or truncate a stored skip symbol depending on the rate adaptation control signal.

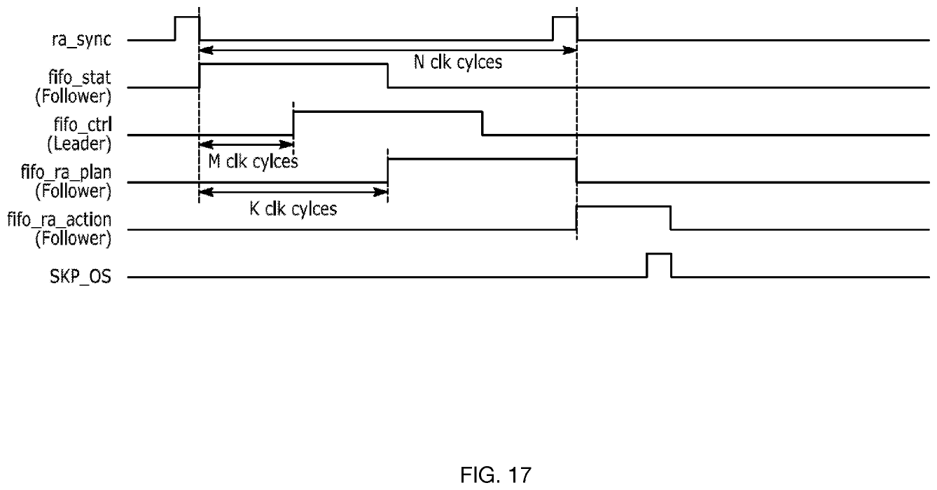

The information exchange is described as follows, and an accompanying timing diagram is shown in FIG. 17. A synchronous ring counter in each tile is permanently incrementing after initiation by the alignment control signal. In doing so, the counters of all lanes run the same, with at most one clock cycle shift between the tiles. All rate adaptation activities are synchronized to this counter, as described in more detail below. Multi-tile rate adaptation takes advantage of the multi-tile lane deskewing described above by synchronizing the counters according to the alignment found signal tx_algn_found generated during lane deskewing.

The ring counter counts from 0 to N−1, where N is programmable. Assuming N=16, the counter repeats every 16 clock cycles. The ring counters are effectively counting clock cycles, and logic is programmed to take various actions at specific count values of the ring counters. The ring counter in each lane of each tile is initialized with the alignment pulse, as previously discussed with regards to multi-tile deskewing. In the timing diagram of FIG. 17, the signal ra_sync is the alignment pulse. As the counters of each tile have been synchronized according to the tx_algn_found signal, the ring counters of each tile generate a synchronization pulse within a single 1 GHz system clock cycle time frame. When a FIFO becomes full or empty, this can be signaled to the leader tile which is only synchronized with the ring counter. A FIFO level status signal fifo_stat is sent to the leader for a certain time, e.g. N/2=8 cycles, which is more than sufficient for the signal to transition from the follower tile to the leader tile.

On the leader tile the FIFO status signals are sync'ed using tech_sync2 cells, and are observed after a couple of cycles. On the leader tile, the FIFO level is evaluated after M clock cycles from the synchronization pulse. M is programmable, and in the timing diagram of FIG. 17, M=4. When programming M, the tile-to-tile transport delay and the synchronization delay are taken into account. A suitable control signal fifo_ctrl is generated: either ‘pad’ (insert a skip) or ‘drop’ (remove a skip). The control signal is stretched for a programmable number of clock cycles to allow for synchronization in the follower tiles. This signal is forwarded back to all follower tiles. As shown in FIG. 13, the multi-lane controller may receive the ctrl_act signal from the ring counter in the leader tile, which may correspond to the count value used to initiate the next action in the sequence of action as laid out in FIG. 17.

In all follower tiles the information is synchronized using tech_sync2 cells and evaluated after K clock cycles from the synchronization pulse. K is programmable as well and is selected to accommodate for tile-to-tile transport delay and synchronization delay. In the timing diagram of FIG. 17, the resulting control signal is fifo_ra_plan (‘plan’ for planned rate adaptation). This signal becomes stable before the next synchronization pulse (ra_sync) from the ring counter. The control logic waits for the next synchronization pulse from the ring counter, e.g., when at N−1 or 0, and activates the pad and truncate logic itself. In the timing diagram of FIG. 17, this is signal fifo_ra_action (rate adaptation active). Since the ring counter operates synchronously to the data stream in all tiles responsive to the tx_algn_found signal from deskewing, any clock skew is automatically compensated. With the occurrence of the next skip ordered set (SKP-OS in the timing diagram of FIG. 17), rate adaption takes place. The distance (i.e., counted number of clock cycles) between the skip ordered set and the synchronization pulse is identical in all tiles and means that a skip removal or a skip insertion is done in all tiles concurrently. If the SKP-OS is to be truncated, then the control logic may double-increment the read pointer for one clock cycle, effectively skipping over the location of the SKP-OS. If a SKP-OS is to be padded, then the control logic may not increment the read pointer for one clock cycle, thus effectively reading the SKP-OS twice.

In the above explanation the ring counter end value (N) becomes clear. N is programmed to be large enough to allow for the complete round-trip, i.e., all tile-to-tile transition delays and synchronization uncertainties are accounted for. A repetitive FIFO-full or FIFO-empty indication is not problematic. Two possible solutions are given below.

When fifo_ra_action is already active, it is kept active. But when the opposite action is requested (e.g. fifo empty after initial fifo full indication), fifo_ra_action may become inactive again. In one scenario, fifo_ra_action stays active until a skip ordered set is present to perform the rate adaptation. When fifo_ra_action is already active, the control logic has requested a rate adaptation operation. If the FIFO level changes further (e.g. due to a missing skip ordered set during long packet transfers), a second or third rate adaptation request can be issued. The request is processed as before and then the pad- and truncate-control logic may store these requests in addition. When, after some time, one or several skip ordered sets come in, several rate adaptation steps can be executed one after the other without further interaction.

For multi-tile rate adaptation, the following signals are used:
rpcs_fifo_sts_o[1:0][1:0] (follower out, one combination for 8-lane mode and one for the 16-lane mode)
rpcs_fifo_sts_i[2:0][1:0] (leader in)
rpcs_fifo_ct_i└1:0┘ (follower in)

The status information uses the following encoding:
2′b 00: All FIFO of follower are within limits (no action required)
2′b 01: Any FIFO of follower is full (request SKP removal)
2′b 10: Ay FIFO of follower is empty (request SKP insertion)
2′b 11: Errors condition, FIFO behaves unexpectedly, inform leader

The control information uses the following encoding:
2′b 00: No action required, keep FIFO unchanged
2′b 01: Remove one SKP ordered set from data stream
2′b 10: Insert one SKP ordered set into the data stream
2′b 11: Error indication, insert ERROR ordered sets into the data stream

Since the multi-lane rate adaptation utilizes the same synchronization concept as for the alignment information exchange. i.e., using reference clock and write tile clocks, there is no need to use Gray-encoding. One challenge may be long turnaround times. When a FIFO is full or empty, a request to either insert or remove a SKP ordered set response will come quickly. However, it takes time until the next SKP ordered set occurs. First when a SKP ordered set was processed (insertion or removal), the FIFO fill level is updated, while in the meantime the Multi-Lane Controller block may have already issued the next FIFO control request, leading to an unintended additional SKP insertion or removal. One possible solution for this issue is to change the FIFO level indication as soon as a FIFO level change control request arrives and update the FIFO level again first after the change request was executed. When a FIFO becomes full or empty, this information is forwarded to the leader tile via the ‘rpcs_fifo_sts’ lines. The leader tile in turn will issue an “insert_skp” request or a “remove_skp” request. Simultaneously the leader tile will internally block any FIFO full or empty indication from follower tiles for N clock cycles, where N is programmable. This blocks unintended subsequent FIFO change requests until the actual request is processed. The FIFO change request is synchronized and forwarded to all follower tiles via the ‘rpcs_fifo_ctl’ lines. The addressed FIFO controller (in each lane individually) will store the request and change the FIFO fill level indications to “normal” until the request can be eventually processed. As soon as a SKP ordered set is detected, the FIFO update request can be executed, and either a SKP is inserted or a SKP is removed. After the request is processed, the FIFO fill level is updated. In case the FIFO level still differs from “normal” the FIFO fill status will be sent to the leader tile via ‘rpcs_fifo_sts’ lines again.

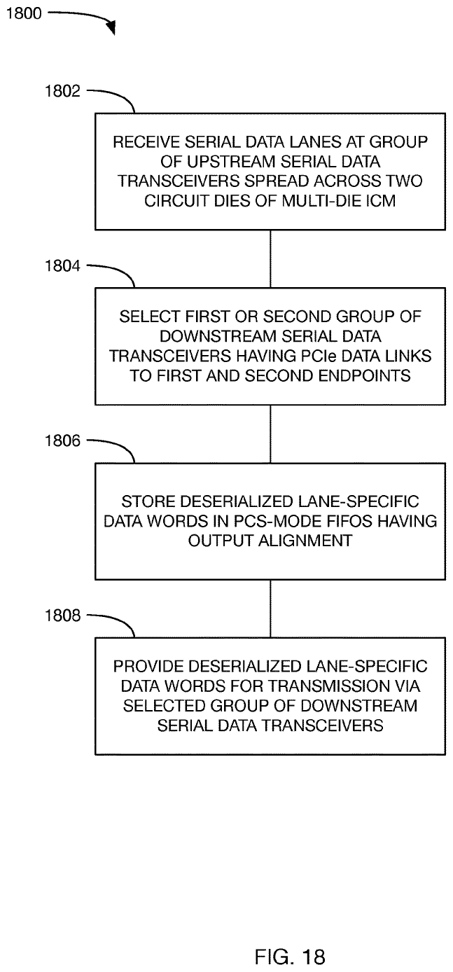

FIG. 18 is a flowchart of a method 1800, in accordance with some embodiments. As shown, method 1800 includes receiving 1802, at a group of upstream serial data transceivers spread across at least two circuit dies of a multi-die integrated circuit module (ICM), a plurality of serial data lanes, and responsively generating respective deserialized lane-specific data words, selecting 1804 a first or a second group of downstream serial data transceivers spread across the at least two circuit dies of the ICM, the first and second group of downstream serial data transceivers having respective PCIe data links to first and second endpoints, respectively, storing 1806 the deserialized lane-specific data words for each serial data lane in corresponding PCS-mode FIFOs associated with the selected group of downstream serial data transceivers, the corresponding PCS-mode FIFOs having output alignment across the plurality of serial data lanes received at the at least two circuit dies, and providing 1808 the deserialized lane-specific data words for transmission via the selected group of downstream serial data transceivers.

While embodiments described above contemplate usage of the PCIe protocol, it should be noted that such implementations may function in equivalent system environments utilizing other protocols, and no limitation is implied via usage of PCIe examples.

We claim:

1. A method comprising:
receiving, at a group of upstream serial data transceivers spread across at least two circuit dies of a multi-die integrated circuit module (ICM), a plurality of serial data lanes associated with a peripheral component interconnect express (PCIe) data link, and responsively generating respective deserialized lane-specific data words;
selecting a first or a second group of downstream serial data transceivers spread across the at least two circuit dies of the ICM, the first and second group of downstream serial data transceivers having respective PCIe data links to first and second endpoints, respectively;
storing the deserialized lane-specific data words for each serial data lane in corresponding PCS-mode first-in-first-out buffers (FIFOs) associated with the selected group of downstream serial data transceivers, the corresponding PCS-mode FIFOs having output alignment across the plurality of serial data lanes received at the at least two circuit dies; and
providing the deserialized lane-specific data words for transmission via the selected group of downstream serial data transceivers.

2. The method of claim 1, wherein the corresponding PCS-mode FIFOs have read pointer locations set responsive to detection of alignment symbols in each of the plurality of serial data lanes, the read pointers synchronously set responsive to an alignment found signal generated according to a reference clock shared between the first and second circuit dies.

3. The method of claim 1, wherein the first endpoint is a primary endpoint and the second endpoint is a redundant endpoint, and wherein the second group of downstream serial data transceivers is selected responsive to a failure on the first PCIe data link.

4. The method of claim 1, wherein the selected group of downstream serial data transceivers is selected using lane routing logic in each circuit die of the ICM.

5. The method of claim 4, wherein the lane routing logic is configured via a CPU on a leader die of the at least two circuit dies of the ICM.

6. The method of claim 4, wherein the leader die communicates with a follower die using a serial peripheral interface (SPI) connection.

7. The method of claim 6, further comprising instructing the leader die to configure the lane routing logic based on command received over a system management bus (SMBus).

8. The method of claim 6, further comprising instructing the leader die to configure the lane routing logic based on command received over a virtual channel.

9. The method of claim 8, wherein the command received over the virtual channel is detected by detecting vendor-defined messages in control skip ordered sets.

10. The method of claim 1, further comprising receiving, at a second group of upstream serial data transceivers spread across the at least two circuit dies of a multi-die ICM, a plurality of serial data lanes associated with a second PCIe data link, and further comprising selecting another of the first and second group of downstream serial data transceivers and responsively routing deserialized lane-specific data words associated with the second PCIe data link to the selected another of the first and second group of downstream serial data transceivers.

11. An apparatus comprising:
An upstream pseudo-port comprising physical layer circuits (PHYs) spread across at least two circuit dies of a multi-die integrated circuit module (ICM), the upstream pseudo-port configured to receive a plurality of serial data lanes associated with a PCIe data link, and to responsively generate respective deserialized lane-specific data words;
lane routing logic in the first and second circuit dies configured to select a first or a second downstream pseudo-port each having PHYs spread across the at least two circuit dies of the ICM;
the first and second downstream pseudo-ports having respective PCIe data links to first and second endpoints, respectively;
PCS-mode FIFOs associated with the selected downstream pseudo-port, the PCS-mode FIFOs configured to store the deserialized lane-specific data words for each serial data lane, the PCS-mode FIFOs having output alignment across the plurality of serial data lanes received at the at least two circuit dies; and
the PHYs of the selected downstream pseudo-port configured to provide the deserialized lane-specific data words for transmission.

12. The apparatus of claim 11, wherein the corresponding PCS-mode FIFOs have read pointer locations set responsive to detection of alignment symbols in each of the plurality of serial data lanes, and wherein the apparatus further comprises synchronization logic in the first and second circuit dies configured to synchronously set the read pointer locations responsive to an alignment pulse generated according to a reference clock shared between the first and second circuit dies.

13. The apparatus of claim 11, wherein the first endpoint is a primary endpoint and the second endpoint is a redundant endpoint, and wherein the lane routing logic is configured to select the second group of downstream pseudo-ports responsive to a failure on the first PCIe data link.

14. The apparatus of claim 11, wherein one of the at least two circuit dies is a leader circuit die, and wherein the lane routing logic in the at least two circuit dies is configured via a CPU on the leader circuit die.

15. The apparatus of claim 14, wherein the leader circuit die communicates with a follower die using a serial peripheral interface (SPI) connection.

16. The apparatus of claim 14, wherein the CPU on the leader circuit die is configured to receive an instruction to configure the multiplexing switching circuits.

17. The apparatus of claim 16, wherein the command is received over a system management bus (SMBus).

18. The apparatus of claim 16, wherein the command is received over a virtual channel.

19. The apparatus of claim 18, further comprising symbol detection logic configured to detect the command received over the virtual channel from vendor-defined messages in control skip ordered sets.

20. The apparatus of claim 11, further comprising a second upstream pseudo-port having PHYs spread across the at least two circuit dies of a multi-die ICM, the second upstream pseudo-port configured to receive a plurality of serial data lanes associated with a second PCIe data link, and wherein the lane routing logic is further configured to select a second of the first and second downstream pseudo-ports and to responsively route deserialized lane-specific data words associated with the second PCIe data link to the selected second downstream pseudo-port.
